(19) United States
(12) Patent Application Publication
(10) Pub. No.: US 2012/0171358 A1
(43) Pub. Date: Jul. 5, 2012

(54) METHOD OF PREPARING CONDUCTIVE POLYMER COMPOSITION AND METHOD OF MANUFACTURING CONDUCTIVE FILM USING THE SAME

(75) Inventors: Youn Soo Kim, Seoul (KR); Yong Hyun Jin, Seoul (KR); Sang Hwa Kim, Gyunggi-do (KR)

(73) Assignee: SAMSUNG ELECTRO-MECHANICS CO., LTD., Gyunggi-do (KR)

(21) Appl. No.: 13/075,589

(22) Filed: Mar. 30, 2011

(30) Foreign Application Priority Data
Jan. 3, 2011 (KR) 1020110000302

(51) Int. Cl. B05D 5/12; H01B 1/12

(52) U.S. Cl. 427/58; 252/500

(57) ABSTRACT

Disclosed is a method of preparing a conductive polymer composition, in which FTS (Ferric p-toluene sulfonate) is used as a dopant and mixed with a conductive polymer monomer before polymerizing the conductive polymer monomer, thereby facilitating the control of the concentration of the conductive polymer composition and increasing the electrical conductivity of the conductive polymer composition. A method of manufacturing a conductive film is also provided.

### CROSS REFERENCE TO RELATED APPLICATION

This application claims the benefit of Korean Patent Application No. 10-2011-0000302, filed Jan. 3, 2011, entitled “Method of preparing conductive polymer composition and method of manufacturing conductive film using the same,” which is hereby incorporated by reference in its entirety into this application.

### BACKGROUND OF THE INVENTION

1. Technical Field

The present invention relates to a method of preparing a conductive polymer composition and a method of manufacturing a conductive film using the same.

2. Description of the Related Art

Alongside the growth of computers using digital technology, devices assisting computers have also been developed, and personal computers, portable transmitters and other personal information processors are used to process text and graphics using a variety of input devices such as keyboards, mouse elements and so forth.

The rapid advancement of the information-based society, which is disseminating the use of computers, is accompanied by the problem of difficulty in efficiently operating products using only the keyboard and the mouse to perform the functions of an input device. Accordingly, there is increasing demand for devices which are simple and infrequently malfunction, and which enable information to be easily input by anyone.

Furthermore, technology for input devices has surpassed the mere level of fulfilling general functions and has progressed toward technology related to high reliability, durability, innovation, designing and manufacturing. To this end, touch panels have been developed as devices capable of inputting information such as text and graphics.

The touch panel is mounted on the display surface of an image display device such as a flat panel display including an electronic organizer, a liquid crystal display (LCD), a plasma display panel (PDP), an electroluminescence (El) element etc., or a cathode ray tube (CRT), so that a user selects the information desired while looking at the image display device.

Also, touch panels are generally classifiable as being of a resistive type, a capacitive type, an electromagnetic type, a SAW (Surface Acoustic Wave) type, and an infrared type. The type of touch panel selected is one that is adapted for an electronic product in consideration of signal amplification problems, resolution differences, the degree of difficulty of designing and manufacturing technology, optical properties, electrical properties, mechanical properties, resistance to the environment, input properties, durability and economic benefits of the touch panel. In particular, resistive touch panels and capacitive touch panels are widely and prevalently used in different fields.

In the case of resistive touch panels, they are configured so that upper/lower transparent electrode films are separated from each other by a spacer and are brought into contact with each other by pressing. Particularly useful are digital resistive type and analog resistive type in such a manner that when an upper conductive film having the upper transparent electrode film is pressed by an input element such as a finger, a pen, etc., the upper/lower transparent electrode films are electrically connected with each other, and changes in voltage in response to changes in resistance at the touch position are sensed by the controller to thus recognize the touch coordinates.

In the case of capacitive touch panels, an upper conductive film having a first transparent electrode and a lower conductive film having a second transparent electrode are spaced apart from each other, and an insulating material is interposed between the first transparent electrode and the second transparent electrode so that these transparent electrodes do not come into contact with each other. Furthermore, electrode wires which are connected to the transparent electrodes are formed on the upper conductive film and the lower conductive film. The electrode wires transfer changes in capacitance occurring from the first transparent electrode and the second transparent electrode to the controller as the touch screen is touched by the input element.

The transparent electrodes have been conventionally formed using ITO (Indium Tin Oxide), but thorough research into conductive polymers as alternatives thereof is ongoing. The conductive polymers are advantageous because of higher flexibility and a simpler coating process, compared to ITO. Because of such advantages, the conductive polymers are receiving attention as an important element of flexible displays corresponding to next-generation technology, as well as the touch panels.

Among conductive polymers, polyethylenedioxythiophene/polystyrenesulfonate (PEDOT/PSS) may exhibit superior electrical conductivity and is thus widely commercially available. A conductive polymer composition containing PEDOT/PSS is prepared by polymerizing a conductive polymer monomer thus forming PEDOT/PSS, and adding other additives such as a binder, a dispersion stabilizer, an additional dopant, etc. However, conventional PEDOT/PSS is disadvantageous because there is a need to adjust the concentrations of PSS, PEDOT and a solvent in order to disperse PEDOT/PSS in water, undesirably complicating the preparation process. Moreover, as the touch screen, display and so on are required to be small-sized and highly integrated, the electrical conductivity of the transparent electrode is regarded as very important, but PEDOT/PSS is problematic because it does not fulfill the electrical conductivity of a transparent electrode when used in lieu of ITO.

### SUMMARY OF THE INVENTION

Accordingly, the present invention has been made bearing in mind the problems encountered in the related art and the present invention is intended to provide a method of preparing a conductive polymer composition, which includes polymerizing a conductive polymer monomer using FTS (Ferric p-toluene sulfonate) as a dopant in place of PSS.

An aspect of the present invention provides a method of preparing a conductive polymer composition, comprising (A) providing a conductive polymer monomer solution comprising a conductive polymer monomer, FTS (Ferric p-toluene sulfonate), a binder and a solvent and (B) polymerizing the conductive polymer monomer solution.

In this aspect, FTS (Ferric p-toluene sulfonate) may be used so that a molar ratio of conductive polymer monomer to FTS is 1:0.5˜1:3.5.

Furthermore, FTS (Ferric p-toluene sulfonate) may be used so that a molar ratio of conductive polymer monomer to FTS is 1:2˜1:3.

In this aspect, the conductive polymer monomer solution may comprise 100 parts by weight of the conductive polymer monomer, 10˜200 parts by weight of the binder, and 5,000˜50,000 parts by weight of the solvent.

In this aspect, polymerizing may be performed using oxidation polymerization.

In this aspect, the binder may be one or more selected from among gelatin, cellulose-, acryl-, epoxy-, ester-, urethane-, ether-, carboxyl-, and amide-based binders.

In this aspect, the conductive polymer monomer may be selected from among thiophene, aniline, pyrrole, acetylene, phenylene and derivatives thereof.

In this aspect, the conductive polymer monomer may be 3,4-ethylenedioxythiophene (EDOT).

In this aspect, the solvent may be any one selected from among aliphatic alcohol, aliphatic ketone, aliphatic carboxylic acid ester, aliphatic carboxylic acid amide, aromatic hydrocarbon, aliphatic hydrocarbon, acetonitrile, aliphatic sulfoxide, water and mixtures thereof.

Another aspect of the present invention provides a method of manufacturing a conductive film, comprising (A) providing a conductive polymer monomer solution comprising a conductive polymer monomer, FTS (Ferric p-toluene sulfonate), a binder and a solvent, (B) polymerizing the conductive polymer monomer solution, thus obtaining a conductive polymer composition, (C) applying the conductive polymer composition on a base member, and (D) drying the base member.

In this aspect, FTS (Ferric p-toluene sulfonate) may be used so that a molar ratio of conductive polymer monomer to FTS is 1:0.5˜1:3.5.

Furthermore, FTS (Ferric p-toluene sulfonate) may be used so that a molar ratio of conductive polymer monomer to FTS is 1:2˜1:3.

In this aspect, the conductive polymer monomer solution may comprise 100 parts by weight of the conductive polymer monomer, 10˜200 parts by weight of the binder, and 5,000˜50,000 parts by weight of the solvent.

In this aspect, polymerizing may be performed using oxidation polymerization.

In this aspect, the binder may be one or more selected from among gelatin, cellulose-, acryl-, epoxy-, ester-, urethane-, ether-, carboxyl-, and amide-based binders.

In this aspect, the conductive polymer monomer may be selected from among thiophene, aniline, pyrrole, acetylene, phenylene and derivatives thereof.

In this aspect, the conductive polymer monomer may be 3,4-ethylenedioxythiophene (EDOT).

In this aspect, the solvent may be any one selected from among aliphatic alcohol, aliphatic ketone, aliphatic carboxylic acid ester, aliphatic carboxylic acid amide, aromatic hydrocarbon, aliphatic hydrocarbon, acetonitrile, aliphatic sulfoxide, water and mixtures thereof.

### BRIEF DESCRIPTION OF THE DRAWING

FIG. 1 is a graph showing the electrical conductivity of conductive films of Examples 1 to 4.

### DESCRIPTION OF SPECIFIC EMBODIMENTS

The features and advantages of the present invention will be more clearly understood from the following detailed description and embodiments. Furthermore, descriptions of known techniques, even if they are pertinent to the present invention, are considered unnecessary and may be omitted in so far as they would make the characteristics of the invention unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

Hereinafter, embodiments of the present invention will be described in detail

According to the present invention, a method of preparing a conductive polymer composition includes (A) providing a conductive polymer monomer solution comprising a conductive polymer monomer, FTS (Ferric p-toluene sulfonate), a binder and a solvent, and (B) polymerizing the conductive polymer monomer solution. Before polymerizing the conductive polymer monomer, the conductive polymer monomer is mixed with the dopant such as FTS, thus facilitating the preparation of the conductive polymer composition possessing high electrical conductivity. Below, the method of preparing the conductive polymer composition is sequentially described.

Specifically, the conductive polymer monomer solution comprising the conductive polymer monomer, the binder and the solvent which are mixed together is first prepared. The conductive polymer monomer and the binder are added to the solvent and then mixed using stirring and sonification, thereby obtaining the conductive polymer monomer solution. The components of the conductive polymer monomer solution are described in detail.

The conductive polymer monomer is an electrically conductive monomer having a single π-electron per carbon atom. A conductive polymer resulting from polymerizing the conductive polymer monomer has a molecular weight of about 10,000 or more. The conductive polymer is advantageous because a thin film that is lighter and more flexible may be obtained than when typically using ITO (Indium Tin Oxide) for a transparent electrode.

The conductive polymer monomer may be selected from among thiophene, aniline, pyrrole, acetylene, phenylene and derivatives thereof. The conductive polymer monomer is advantageous because the polymerization thereof is easy and electrical conductivity becomes increased.

Particularly useful as the conductive polymer monomer is 3,4-ethylenedioxythiophene (EDOT). This 3,4-ethylenedioxythiophene (EDOT) is polymerized thus obtaining polyethylenedioxythiophene (PEDOT) possessing high electrical conductivity and thermal stability.

Used as a dopant and oxidizer, FTS (Ferric p-toluene sulfonate) is added to the conductive polymer monomer solution. The conductive polymer having a single π-electron per carbon atom needs a material functioning as a charge carrier which adds or removes charges to or from part of the π orbital function thereof so as to exhibit electrical conductivity. Such a material is referred to as a dopant. In the case of polystyrenesulfonate typically used as the dopant, the concentrations of PSS, PEDOT and the solvent should be adjusted so that they are dissolved in water, and the process of preparing a conductive polymer composition is undesirably complicated. Whereas, because FTS in a wide concentration range may be efficiently mixed with the solvent such as alcohol and the conductive polymer monomer, it is easy to adjust the concentration of the conductive polymer composition upon preparation of the conductive polymer composition using FTS as the dopant. In the case where the conductive polymer is prepared using FTS as the dopant, a conductive film having high electrical conductivity as shown in the following test example may be obtained.

Also, FTS is used as the dopant to polymerize the conductive polymer monomer and simultaneously functions as the oxidizer, and thus the energy level of the polymerized conductive polymer is lowered so that electrons are easily transferred to a high energy state, thereby increasing the electrical conductivity of the conductive polymer composition.

The conductive polymer monomer and FTS are used at a molar ratio of 1:0.5˜1:3.5, particularly favored being 1:2˜1:3. If the molar ratio of conductive polymer monomer to FTS is less than 1:0.5, the degree of increasing the electrical conductivity due to the addition of FTS is insignificant. In contrast, if the molar ratio thereof is larger than 1:3.5, there is no effect of increasing the electrical conductivity due to the addition of FTS.

The binder is added to enhance the force of adhesion to a substrate. The binder may be one or more selected from among gelatin, cellulose-, acryl-, epoxy-, ester-, urethane-, ether-, carboxyl-, and amide-based binders. These examples are merely illustrative, and the present invention is not limited thereto.

As such, the binder is used in an amount of 10˜200 parts by weight relative to 100 parts by weight of the conductive polymer monomer. Particularly favored is 40˜60 parts by weight. If the amount of the binder is less than 10 parts by weight, the degree of enhancing adhesion is lowered. In contrast, if the amount thereof is larger than 200 parts by weight, it is excessively increased compared to the amount of the conductive polymer monomer, undesirably reducing the electrical conductivity of the conductive polymer composition.

The solvent is used to disperse the conductive polymer monomer in a solution. The solvent may include any one selected from among aliphatic alcohol, aliphatic ketone, aliphatic carboxylic acid ester, aliphatic carboxylic acid amide, aromatic hydrocarbon, aliphatic hydrocarbon, acetonitrile, aliphatic sulfoxide, water, and mixtures thereof. These examples are merely illustrative, and the present invention is not limited thereto.

The solvent is used in an amount of 5,000˜50,000 parts by weight, particularly favored being 7,000˜30,000 parts by weight, relative to 100 parts by weight of the conductive polymer monomer. If the amount of the solvent is less than 5,000 parts by weight, dispersibility of the conductive polymer is decreased. In contrast, if the amount thereof is larger than 50,000 parts by weight, the electrical conductivity of the conductive polymer composition is decreased.

In the present invention, the conductive polymer monomer solution may further include a dispersion stabilizer, a surfactant, an antifoamer, etc.

Subsequently, the conductive polymer monomer solution thus prepared is polymerized, thus preparing the conductive polymer composition. In the present invention, the conductive polymer monomer is mixed with FTS in lieu of PSS which is typically used, and is then polymerized, thus increasing the electrical conductivity of the conductive polymer. Furthermore, the conductive polymer composition may be easily prepared without the need to adjust the concentrations of PSS, the conductive polymer monomer and the solvent.

The polymerization of the conductive polymer monomer solution may include chemical polymerization, electrochemical polymerization, thermal polymerization, photopolymerization, etc.

In the chemical polymerization, oxidation polymerization is adopted so that the conductive polymer is prepared. The oxidation polymerization is advantageous in terms of low cost and a simple polymerization process. The oxidation polymerization is used so that a monomer is oxidized using an oxidizer such as Lewis acid and thus polymerized into a conductive polymer.

In addition, according to an embodiment of the present invention, a method of manufacturing a conductive film includes (A) providing a conductive polymer monomer solution comprising a conductive polymer monomer, FTS (Ferric p-toluene sulfonate), a binder and a solvent, (B) polymerizing the conductive polymer monomer solution thus preparing a conductive polymer composition, (C) applying the conductive polymer composition on a base member, and (D) drying the base member. The method of manufacturing the conductive film is specified below. The description that overlaps with the aforementioned description is omitted or simply described.

Specifically, the conductive polymer monomer solution comprising the conductive polymer monomer, FTS (Ferric p-toluene sulfonate), the binder and the solvent is first prepared.

The molar ratio of conductive polymer monomer to FTS falls in the range of 1:0.5˜1:3.5, particularly favored being 1:2˜1:3. The method of manufacturing the conductive film according to the present invention is advantageous because FTS is used as the dopant in the polymerization of the conductive polymer monomer, thus exhibiting high electrical conductivity of the conductive film and simplifying the manufacturing process.

Also, the conductive polymer monomer solution may be composed of 100 parts by weight of the conductive polymer monomer, 10˜200 parts by weight of the binder, and 5,000˜50,000 parts by weight of the solvent.

Next, the conductive polymer monomer solution is polymerized thus preparing the conductive polymer composition. The polymerization of the conductive polymer monomer solution is performed using oxidation polymerization which is advantageous in terms of low cost and a simple polymerization process.

Next, the conductive polymer composition is applied on the base member. The conductive polymer composition may be applied by being patterned using a dry process or a wet process. Examples of the dry process include sputtering, evaporation, etc., and examples of the wet process include dip coating, spin coating, roll coating, spray coating, etc.

The base member, which is transparent, includes a glass substrate, a film substrate, a fiber substrate, or a paper substrate. In particular, the film substrate may be made of polyethyleneterephthalate (PET), polymethylmethacrylate (PMMA), polypropylene (PP), polyethylene (PE), polyethylenenaphthalene dicarboxylate (PEN), polycarbonate (PC), polyethersulfone (PES), polyimide (PI), polyvinyl alcohol (PVA), cyclic olefin copolymer (COC), or styrene copolymer, but the present invention is not necessarily limited thereto.

Next, the base member coated with the conductive polymer composition is dried. When the applied conductive polymer composition is dried, a transparent electrode in fixed form is obtained. The drying process is performed using hot air drying, IR drying, etc.

A better understanding of the present invention may be obtained via the following examples which are set forth to illustrate, but are not to be construed as limiting the present invention.

### Example 1

Into a 100 ml round-bottom reactor, 0.4 mol (3 g) a solvent n-butanol, 0.12 g of an acrylic binder, 0.422 mmol (0.06 g) a conductive polymer monomer 3,4-ethylenedioxythiophene (EDOT), and 1.26 mmol (0.854 g) FTS (Ferric p-toluene sulfonate) in which a molar ratio of conductive polymer monomer to FTS was 1:2.98 were added, after which 30-min stirring and sonification were performed, thus preparing a conductive polymer monomer solution. Thereafter, the conductive polymer monomer solution was subjected to oxidation polymerization using an oxidizer at 25° C. for 3 hours, thus preparing a PEDOT/FTS conductive polymer composition. The conductive polymer composition was then applied on a base member using spin coating and then dried in an oven at 70° C. for 30 min, thus manufacturing a conductive film.

### Example 2

A conductive polymer composition was prepared in the same manner as in Example 1, with the exception that 0.844 mmol (0.572 g) FTS was added so that a molar ratio of conductive polymer monomer to FTS was 1:2.

The conductive polymer composition was applied on a base member using spin coating and then dried in an oven at 70° C. for 30 min, thus manufacturing a conductive film.

### Example 3

A conductive polymer composition was prepared in the same manner as in Example 1, with the exception that 0.422 mmol (0.286 g) FTS was added so that a molar ratio of conductive polymer monomer to FTS was 1:1.

The conductive polymer composition was applied on a base member using spin coating and then dried in an oven at 70° C. for 30 min, thus manufacturing a conductive film.

### Example 4

A conductive polymer composition was prepared in the same manner as in Example 1, with the exception that 1.477 mmol (1 g) FTS was added so that a molar ratio of conductive polymer monomer to FTS was 1:3.5.

The conductive polymer composition was applied on a base member using spin coating and then dried in an oven at 70° C. for 30 min, thus manufacturing a conductive film.

### Comparative Example

A conductive polymer composition was prepared in the same manner as in Example 1, with the exception that 1.26 mmol polystyrenesulfonate (PSS) was used as the dopant in lieu of FTS so that a molar ratio of conductive polymer monomer to PSS was 1:2.98.

The conductive polymer composition was applied on a base member using spin coating and then dried in an oven at 70° C. for 30 min, thus manufacturing a conductive film.

<Test Example>

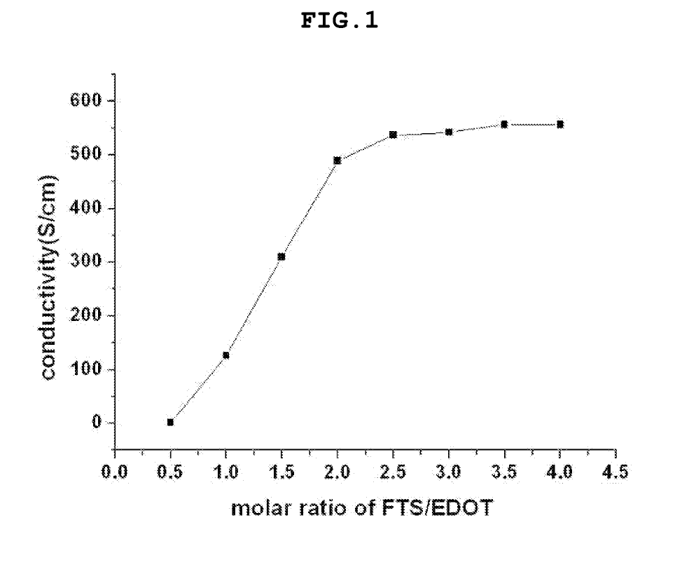

The electrical conductivity of the conductive films manufactured from the conductive polymer compositions of Examples 1 to 4 and Comparative Example was evaluated. The electrical conductivity was measured using Loresta EP MCP-T360 available from Mitsubishi Chemical. FIG. 1 is a graph showing the electrical conductivity of the conductive films of Examples 1 to 4.

TABLE 1

| | Electrical Conductivity (S/cm) |
|---|---|
| Ex. 1 | 500 |
| Ex. 2 | 470 |
| Ex. 3 | 120 |
| Ex. 4 | 515 |
| C. Ex. | 110 |

As is apparent from Table 1, when FTS was used as a dopant, electrical conductivity was superior compared to when using PSS (Comparative Example). Furthermore, when FTS was added at a molar ratio of conductive polymer monomer to FTS ranging from 1:2 to 1:3, the degree of increasing the electrical conductivity of the conductive film was the greatest.

As described hereinbefore, the present invention provides a method of preparing a conductive polymer composition and a method of manufacturing a conductive film. According to the present invention, FTS (Ferric p-toluene sulfonate) is used as a dopant and mixed with a conductive polymer monomer before polymerizing the conductive polymer monomer, thereby facilitating the control of the concentration of the conductive polymer composition and increasing the electrical conductivity of the conductive polymer composition.

Although the embodiments of the present invention regarding the method of preparing a conductive polymer composition and the method of manufacturing a conductive film have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A method of preparing a conductive polymer composition, comprising:
(A) providing a conductive polymer monomer solution comprising a conductive polymer monomer, FTS (Ferric p-toluene sulfonate), a binder and a solvent; and
(B) polymerizing the conductive polymer monomer solution.

2. The method of claim 1, wherein the FTS (Ferric p-toluene sulfonate) is used so that a molar ratio of conductive polymer monomer to FTS is 1:0.5˜1:3.5.

3. The method of claim 1, wherein the FTS (Ferric p-toluene sulfonate) is used so that a molar ratio of conductive polymer monomer to FTS is 1:2˜1:3.

4. The method of claim 1, wherein the conductive polymer monomer solution comprises 100 parts by weight of the conductive polymer monomer, 10˜200 parts by weight of the binder, and 5,000˜50,000 parts by weight of the solvent.

5. The method of claim 1, wherein the polymerizing is performed using oxidation polymerization.

6. The method of claim 1, wherein the binder is one or more selected from among gelatin, cellulose-, acryl-, epoxy-, ester-, urethane-, ether-, carboxyl-, and amide-based binders.

7. The method of claim 1, wherein the conductive polymer monomer is selected from among thiophene, aniline, pyrrole, acetylene, phenylene and derivatives thereof.

8. The method of claim 1, wherein the conductive polymer monomer is 3,4-ethylenedioxythiophene (EDOT).

9. The method of claim 1, wherein the solvent is any one selected from among aliphatic alcohol, aliphatic ketone, aliphatic carboxylic acid ester, aliphatic carboxylic acid amide, aromatic hydrocarbon, aliphatic hydrocarbon, acetonitrile, aliphatic sulfoxide, water and mixtures thereof.

10. A method of manufacturing a conductive film, comprising:
(A) providing a conductive polymer monomer solution comprising a conductive polymer monomer, FTS (Ferric p-toluene sulfonate), a binder and a solvent;
(B) polymerizing the conductive polymer monomer solution, thus obtaining a conductive polymer composition;
(C) applying the conductive polymer composition on a base member; and
(D) drying the base member.

11. The method of claim 10, wherein the FTS (Ferric p-toluene sulfonate) is used so that a molar ratio of conductive polymer monomer to FTS is 1:0.5˜1:3.5.

12. The method of claim 10, wherein the FTS (Ferric p-toluene sulfonate) is used so that a molar ratio of conductive polymer monomer to FTS is 1:2˜1:3.

13. The method of claim 10, wherein the conductive polymer monomer solution comprises 100 parts by weight of the conductive polymer monomer, 10˜200 parts by weight of the binder, and 5,000˜50,000 parts by weight of the solvent.

14. The method of claim 10, wherein the polymerizing is performed using oxidation polymerization.

15. The method of claim 10, wherein the binder is one or more selected from among gelatin, cellulose-, acryl-, epoxy-, ester-, urethane-, ether-, carboxyl-, and amide-based binders.

16. The method of claim 10, wherein the conductive polymer monomer is selected from among thiophene, aniline, pyrrole, acetylene, phenylene and derivatives thereof.

17. The method of claim 10, wherein the conductive polymer monomer is 3,4-ethylenedioxythiophene (EDOT).

18. The method of claim 10, wherein the solvent is any one selected from among aliphatic alcohol, aliphatic ketone, aliphatic carboxylic acid ester, aliphatic carboxylic acid amide, aromatic hydrocarbon, aliphatic hydrocarbon, acetonitrile, aliphatic sulfoxide, water and mixtures thereof.
